(19) United States
(12) Patent Application Publication
(10) Pub. No.: US 2026/0037811 A1
(43) Pub. Date: Feb. 5, 2026

(54) LANGUAGE MODEL ALIGNMENT WITHOUT ALIGNMENT OPERATION

(71) Applicant: Intuit Inc., Mountain View, CA (US)

(72) Inventors: Shai Ardazi, Petach-Tikva (IL); Lior Vassertail Azroel, Rosh-Ha’ain (IL); Matan Vetzler, Givatayim (IL); Nitzan Gado, Ness-Ziona (IL)

(73) Assignee: Intuit Inc., Mountain View, CA (US)

(21) Appl. No.: 18/788,600

(22) Filed: Jul. 30, 2024

(51) Int. Cl. G06N 3/0895

(52) U.S. Cl. CPC G06N 3/0895

(57) ABSTRACT

Systems and methods for aligning a language model (LM) are disclosed herein. An example method is performed by one or more processors of a computing system. The example method may include: receiving, over a communications network coupled to the computing system, an LM including a set of neural network parameters; obtaining a set of delta values representative of a difference between a prior LM's neural network parameters before a performance of an alignment operation and the prior LM's neural network parameters after the performance of the alignment operation, the alignment operation performed using alignment data for aligning the prior LM's output with at least one of a tone, voice, or safety preference; and adjusting the LM's neural network parameters based on the set of delta values such that, without undergoing the alignment operation, an expected output of the LM aligns with the at least one tone, voice, or safety preference.

### TECHNICAL FIELD

This disclosure relates generally to alignment of neural network (NN)-based artificial intelligence (AI) models, and specifically to alignment of a language model (LM).

### DESCRIPTION OF RELATED ART

A neural network (NN) is a specific type of artificial intelligence (AI) model composed of interconnected nodes organized in layers. These nodes use adjustable parameters (e.g., weights and biases) to process and learn from data. Natural language processing (NLP) focuses on enabling computers to understand, interpret, and generate human language. NNs have brought about many advancements in NLP, such as with respect to machine translation, sentiment analysis, text generation, among other examples. Language models (LMs) are a type of advanced NLP model based on the transformer NN architecture. A transformer uses an attention mechanism to process sequential data, such as text, by weighing the importance of different words or tokens in a sequence, where tokens are individual units of text, such as a set of words, characters, or subwords. LMs typically train on large amounts of text data and learn millions of NN parameters, enabling them to understand, interpret, and generate human language. Large language models (LLMs) are trained on even larger amounts of text data to perform even more complex language tasks, and may incorporate neural networks with billions or even trillions of NN parameters.

Training LMs is computationally intensive and typically involves pretraining and fine-tuning. Pretraining includes training the LM on a massive text corpora so that the LM learns a general representation of language, often involving trillions of tokens and requiring weeks of computation on advanced hardware. Fine-tuning can tailor a pretrained LM to a specific downstream task using a smaller, task-specific dataset, typically in the order of millions or billions of tokens and requiring days of training. Supervised fine-tuning (SFT) is a common technique used to fine-tune a pretrained LM on labeled data for a target task, such as content generation, article summarization, classification, or the like. Specifically, SFT may be used to fine-tune different LMs on different labeled knowledge bases to create different specialized versions of the same pretrained LM that each perform a different task. For example, a pretrained LM may be fine-tuned on a knowledge base of fantasy novels to perform the task of helping authors write fantasy novels, and another instance of the same pretrained LM may be fine-tuned on a dataset of screenplays to perform the task of helping with scriptwriting. As other examples, an LM may be fine-tuned on a dataset of historical texts to answer questions about history, while another LM may be fine-tuned on a knowledge base of scientific papers to provide summaries of scientific concepts. As knowledge and tuning data often change frequently, such fine-tuning operations may often be iterative. That is, a fine-tuned LM may be fine-tuned again using new data as it becomes available.

The fine-tuning process also often includes a formal alignment operation that shapes the LM's outputs to exhibit desired attributes, such as appropriate tone, voice, safety, and/or ethical standards. For example, an LM may be aligned to generate output that is friendly, concise, and easy to understand. As another example, an LM may be aligned to generate output that adheres to a defined set of ethical guidelines and/or to avoid generating output that may be interpreted as biased, harmful, or offensive. In other words, rather than adding factual knowledge to the LM (as in the SFT examples described above), formal alignment operations are used to instill desirable behavior and values in the LM. Common formal alignment operations are often performed during the SFT process and include reinforcement learning from human feedback (RLHF), direct preference optimization (DPO), inverse reinforcement learning (IRL), proximal policy optimization (PPO), constitutional AI (CAI), and reward modeling, among other examples. The process for performing such formal alignment operations typically involves using training data that represents human judgment or feedback, performing several iterations based on feedback, gradually tuning preferences and objectives, and making careful decisions about various safety and ethical considerations. For example, RLHF uses a reward model trained on human preferences to align an LM using reinforcement learning (RL) techniques. As another example, DPO aligns an LM directly (without a reward model) using pairs of queries, chosen answers (i.e., preferred outputs), and rejected answers (i.e., undesirable outputs).

Like pretraining and task-based fine-tuning operations in general (like SFT), performing formal alignment operations (like DPO) demands substantial computational resources, financial costs, and time. What is needed is a streamlined approach to effectively aligning a model that can save computational resources, financial costs, and time.

### SUMMARY

This Summary is provided to introduce in a simplified form a selection of concepts that are further described below in the Detailed Description. This Summary is not intended to identify key features or essential features of the claimed subject matter, nor is it intended to limit the scope of the claimed subject matter.

One innovative aspect of the subject matter described in this disclosure can be implemented as a method for aligning a language model (LM). An example method is performed by one or more processors of a computing system and can include receiving, over a communications network coupled to the computing system, an LM including a set of neural network (NN) parameters. The method can also include obtaining a set of delta values representative of a difference between a prior LM's NN parameters before a performance of an alignment operation and the prior LM's NN parameters after the performance of the alignment operation, the alignment operation performed using alignment data for aligning the prior LM's output with at least one of a tone, voice, or safety preference. The method can also include adjusting the LM's NN parameters based on the set of delta values such that, without undergoing the alignment operation, an expected output of the LM aligns with the at least one tone, voice, or safety preference.

In some implementations, the LM is a large language model (LLM) pretrained using a text corpus. In some aspects, the LM's NN parameters include a plurality of weights. In some instances, the plurality of weights include at least one of bias weights, attention weights, query weights, key weights, or value weights. In some implementations, the set of delta values is stored in a set of tensors. In some aspects, the set of tensors is stored in a safetensor format. In some implementations, adjusting the LM's NN parameters includes simultaneously adding, in a high-dimensional tensor space, each respective delta value of the set of delta values to a parameter of the LM's NN parameters that corresponds to the respective delta value, where the simultaneous adding of each delta value is performed at least nearly instantaneously. In some implementations, the alignment operation includes at least one of a direct preference optimization (DPO) operation or a reinforcement learning (RL) operation. In some aspects, the method can also include obtaining a first snapshot of the alignment data stored at a time of the performance of the alignment operation, obtaining a second snapshot of current alignment data, and determining that the first snapshot matches the second snapshot, where the set of delta values is obtained responsive to the determining.

In some instances, a first set of the prior LM's NN parameters is determined before the performance of the alignment operation, a second set of the prior LM's NN parameters is determined after the performance of the alignment operation, and the difference is generated based on the first and second sets of the prior LM's NN parameters. In some implementations, the first set of the prior LM's NN parameters is determined after a first fine-tuning operation is performed on the prior LM. In some instances, the first fine-tuning operation includes a supervised fine-tuning (SFT) operation. In some implementations, the first fine-tuning operation is performed using tuning data for fine-tuning the prior LM to perform a first task based on a first knowledge base. In some implementations, the method can further include performing, prior to adjusting the LM's NN parameters, the first fine-tuning operation on the LM such that the LM performs the first task based on the first knowledge base. In some aspects, the LM is an update model of the prior LM. In some implementations, the method can further include performing, prior to adjusting the LM's NN parameters, a second fine-tuning operation on the LM such that the LM performs a second task different than the first task. In some aspects, the LM is an initial model fine-tuned for performing the second task based on a second knowledge base different than the first knowledge base.

In some other implementations, the method can further include obtaining a first score generated based on a first benchmark evaluation of the prior LM, where the first benchmark evaluation determines a quantitative extent to which the prior LM aligns with the at least one tone, voice, or safety preference, obtaining a second score generated based on a second benchmark evaluation of the LM, where the second benchmark evaluation determines a quantitative extent to which the LM aligns with the at least one tone, voice, or safety preference, and comparing a score difference between the first and second scores with a threshold. In some instances, the method can further include selectively submitting the LM for deployment based on whether the score difference is above the threshold.

Another innovative aspect of the subject matter described in this disclosure can be implemented in a computing system for aligning an LM. An example system includes one or more processors and at least one memory coupled to the one or more processors and storing instructions that, when executed by the one or more processors, cause the system to perform operations. The operations can include receiving, over a communications network coupled to the computing system, an LM including a set of neural network (NN) parameters. The operations can also include obtaining a set of delta values representative of a difference between a prior LM's NN parameters before a performance of an alignment operation and the prior LM's NN parameters after the performance of the alignment operation, the alignment operation performed using alignment data for aligning the prior LM's output with at least one of a tone, voice, or safety preference. The operations can also include adjusting the LM's NN parameters based on the set of delta values such that, without undergoing the alignment operation, an expected output of the LM aligns with the at least one tone, voice, or safety preference.

In some implementations, the LM is a large language model (LLM) pretrained using a text corpus. In some aspects, the LM's NN parameters include a plurality of weights. In some instances, the plurality of weights include at least one of bias weights, attention weights, query weights, key weights, or value weights. In some implementations, the set of delta values is stored in a set of tensors. In some aspects, the set of tensors is stored in a safetensor format. In some implementations, adjusting the LM's NN parameters includes simultaneously adding, in a high-dimensional tensor space, each respective delta value of the set of delta values to a parameter of the LM's NN parameters that corresponds to the respective delta value, where the simultaneous adding of each delta value is performed at least nearly instantaneously. In some implementations, the alignment operation includes at least one of a direct preference optimization (DPO) operation or a reinforcement learning (RL) operation. In some aspects, the method can also include obtaining a first snapshot of the alignment data stored at a time of the performance of the alignment operation, obtaining a second snapshot of current alignment data, and determining that the first snapshot matches the second snapshot, where the set of delta values is obtained responsive to the determining.

In some instances, a first set of the prior LM's NN parameters is determined before the performance of the alignment operation, a second set of the prior LM's NN parameters is determined after the performance of the alignment operation, and the difference is generated based on the first and second sets of the prior LM's NN parameters. In some implementations, the first set of the prior LM's NN parameters is determined after a first fine-tuning operation is performed on the prior LM. In some instances, the first fine-tuning operation includes a supervised fine-tuning (SFT) operation. In some implementations, the first fine-tuning operation is performed using tuning data for fine-tuning the prior LM to perform a first task based on a first knowledge base. In some implementations, the operations can further include performing, prior to adjusting the LM's NN parameters, the first fine-tuning operation on the LM such that the LM performs the first task based on the first knowledge base. In some aspects, the LM is an update model of the prior LM. In some implementations, the operations can further include performing, prior to adjusting the LM's NN parameters, a second fine-tuning operation on the LM such that the LM performs a second task different than the first task. In some aspects, the LM is an initial model fine-tuned for performing the second task based on a second knowledge base different than the first knowledge base.

In some other implementations, the operations can further include obtaining a first score generated based on a first benchmark evaluation of the prior LM, where the first benchmark evaluation determines a quantitative extent to which the prior LM aligns with the at least one tone, voice, or safety preference, obtaining a second score generated based on a second benchmark evaluation of the LM, where the second benchmark evaluation determines a quantitative extent to which the LM aligns with the at least one tone, voice, or safety preference, and comparing a score difference between the first and second scores with a threshold. In some instances, the operations can further include selectively submitting the LM for deployment based on whether the score difference is above the threshold.

Another innovative aspect of the subject matter described in this disclosure can be implemented as a non-transitory computer-readable medium storing instructions that, when executed by one or more processors of a system for aligning an LM, cause the system to perform operations. Example operations include receiving, over a communications network coupled to the computing system, an LM including a set of neural network (NN) parameters, obtaining a set of delta values representative of a difference between a prior LM's NN parameters before a performance of an alignment operation and the prior LM's NN parameters after the performance of the alignment operation, the alignment operation performed using alignment data for aligning the prior LM's output with at least one of a tone, voice, or safety preference, and adjusting the LM's NN parameters based on the set of delta values such that, without undergoing the alignment operation, an expected output of the LM aligns with the at least one tone, voice, or safety preference.

In some implementations, the LM is a large language model (LLM) pretrained using a text corpus. In some aspects, the LM's NN parameters include a plurality of weights. In some instances, the plurality of weights include at least one of bias weights, attention weights, query weights, key weights, or value weights. In some implementations, the set of delta values is stored in a set of tensors. In some aspects, the set of tensors is stored in a safetensor format. In some implementations, adjusting the LM's NN parameters includes simultaneously adding, in a high-dimensional tensor space, each respective delta value of the set of delta values to a parameter of the LM's NN parameters that corresponds to the respective delta value, where the simultaneous adding of each delta value is performed at least nearly instantaneously. In some implementations, the alignment operation includes at least one of a direct preference optimization (DPO) operation or a reinforcement learning (RL) operation. In some aspects, the method can also include obtaining a first snapshot of the alignment data stored at a time of the performance of the alignment operation, obtaining a second snapshot of current alignment data, and determining that the first snapshot matches the second snapshot, where the set of delta values is obtained responsive to the determining.

In some instances, a first set of the prior LM's NN parameters is determined before the performance of the alignment operation, a second set of the prior LM's NN parameters is determined after the performance of the alignment operation, and the difference is generated based on the first and second sets of the prior LM's NN parameters. In some implementations, the first set of the prior LM's NN parameters is determined after a first fine-tuning operation is performed on the prior LM. In some instances, the first fine-tuning operation includes a supervised fine-tuning (SFT) operation. In some implementations, the first fine-tuning operation is performed using tuning data for fine-tuning the prior LM to perform a first task based on a first knowledge base. In some implementations, the operations can further include performing, prior to adjusting the LM's NN parameters, the first fine-tuning operation on the LM such that the LM performs the first task based on the first knowledge base. In some aspects, the LM is an update model of the prior LM. In some implementations, the operations can further include performing, prior to adjusting the LM's NN parameters, a second fine-tuning operation on the LM such that the LM performs a second task different than the first task. In some aspects, the LM is an initial model fine-tuned for performing the second task based on a second knowledge base different than the first knowledge base.

In some other implementations, the operations can further include obtaining a first score generated based on a first benchmark evaluation of the prior LM, where the first benchmark evaluation determines a quantitative extent to which the prior LM aligns with the at least one tone, voice, or safety preference, obtaining a second score generated based on a second benchmark evaluation of the LM, where the second benchmark evaluation determines a quantitative extent to which the LM aligns with the at least one tone, voice, or safety preference, and comparing a score difference between the first and second scores with a threshold. In some instances, the operations can further include selectively submitting the LM for deployment based on whether the score difference is above the threshold.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example computing system, according to some implementations.

FIG. 2 shows an example process flow for aligning a model, according to some implementations.

FIG. 3 shows an example process flow for generating delta values, according to some implementations.

FIG. 4 shows an example process flow for selectively generating delta values or aligning a model using delta values, according to some implementations.

FIG. 5 shows an example process flow for aligning an update model, according to some implementations.

FIG. 6 shows an example process flow for aligning an initial model, according to some implementations.

FIG. 7 shows an illustrative flowchart depicting an example operation for aligning a language model (LM), according to some implementations.

Like numbers reference like elements throughout the drawings and specification.

### DETAILED DESCRIPTION

As described above, training a language model (LM), especially a large language model (LLM), involves extensive computation during pretraining on massive text corpora and fine-tuning on smaller, task-specific datasets. Supervised fine-tuning (SFT) may be used to tailor the LM to specific tasks by training on labeled data, creating specialized versions of a same pretrained model for different purposes. As also described above, the fine-tuning process often includes alignment to ensure the LM's outputs meet desired attributes like appropriate tone, voice, ethical guidelines, and safety standards. Formal alignment operations, like reinforcement learning from human feedback (RLHF) and direct preference optimization (DPO), may be used to instill preferred behaviors and values in an LM without adding task-specific knowledge. However, like pretraining and task-based fine-tuning operations in general, typical formal alignment operations also demand substantial computational resources and time-thus, a streamlined approach to model alignment is needed.

Aspects of the present disclosure recognize that the tuning data used to perform task-specific fine-tuning operations (such as the SFT examples described above) generally varies considerably across different models and over time due to diverse task requirements and ever-changing knowledge bases. In contrast, because core human preferences and ethical considerations tend to remain relatively consistent, alignment data tends to remain relatively static across models and over time, particularly within a single organization. Implementations of the subject matter described in this disclosure may be used to leverage the static nature of alignment data to effectively align an LM such that, without undergoing a formal alignment operation, an expected output of the LM aligns with a desired tone, voice, safety preference, ethical guideline, or the like. In particular, implementations of the subject matter described in this disclosure may be used to align an initial LM (e.g., a first model fine-tuned for a particular task) or an update LM (e.g., a new version of a previous model fine-tuned for a particular task) while refraining from performing any of the computationally intensive formal alignment operations described above or equivalents, such as during SFT. To accomplish this, the innovative computing system described herein uses delta weights associated with a prior LM that was previously aligned using a formal alignment operation. Specifically, an LM including a set of neural network (NN) parameters is received, delta values representative of a difference between the prior LM's NN parameters before-and-after the formal alignment operation are obtained, and the LM's NN parameters are adjusted based on the delta values such that, without undergoing the formal alignment operation, an expected output of the LM aligns with the same tone, voice, safety, or ethical preferences that the prior LM was formally aligned to output.

The computing system described herein provides several technical benefits over conventional solutions for aligning LMs. The inventors' alignment-based benchmark evaluations compared outputs of formally aligned LMs, unaligned LMs, and LMs aligned in the innovative manners described herein. Their experiments show that the LMs aligned in the innovative manners described herein perform at least within an acceptable threshold of performance as compared with the formally aligned LMs. Specifically, as compared with their unaligned counterparts, the alignment evaluation scores for LMs aligned in the innovative manners described herein increased at least nearly as much as the LMs aligned using the computationally intensive formal alignment operations mentioned above (e.g., DPO) while reducing the amount of time spent “aligning” the LM by over 1300 times. By eliminating the reliance on computationally intensive formal alignment operations, the computing system described herein decreases the time and resources required for aligning LMs, enabling quicker model deployment, and allowing redistribution of the time and resources. Furthermore, by lowering the computational demands of alignment, the computing system described herein allows more accessible hardware to be used for alignment, allowing a wider diversity of organizations and individual developers to align their LMs, as well as reducing environmental impact. For example, by eliminating the need for performing one of the common formal alignment operations described above or an equivalent, the computing system described herein eliminates the need, when aligning an LM, to perform model debiasing, to train a reward model, to gather and annotate alignment training data, to perform multiple rounds of alignment training iterations, to integrate feedback, and/or to perform advanced DPO calculations, among many other examples.

Aspects of the subject matter disclosed herein are not an abstract idea such as a mental process that can be performed in the human mind. Although the techniques described herein reduce the intensity of required processing for computers as compared with conventional techniques, the innovative techniques described herein remain far beyond the capabilities of the human mind. For example, the human mind is not capable of receiving an LM including NN parameters over a communications network (e.g., the Internet). Nor is the human mind capable of selectively adjusting an LM's (millions, billions, or trillions of) NN parameters based on delta values, much less when the delta values are stored in tensors in a high-dimensional tensor space (i.e., 4D or higher). Specifically, the human mind is neither equipped nor capable of simultaneously adding, in the high-dimensional tensor space, each respective delta value to a corresponding one of the LM's NN parameters-let alone performing such a task nearly instantaneously with obtaining the delta values. Further, the human mind is not capable of implementing any artificial neural network (ANN) models, and so for example the human mind is not capable of implementing an LM or an LLM, much less determining NN parameters of an LM before-and-after an alignment operation, generating NN parameter delta values, performing a fine-tuning operation, nor performing many of the other actions performable by the computing system described herein.

In addition, aspects of the subject matter disclosed herein are not an abstract idea such as a method of organizing human activity because the claims of this patent application do not recite any fundamental economic practice, commercial interaction, legal interaction, or business relations. Moreover, various implementations of the subject matter disclosed herein provide technical solutions to the technical problem of improving the capability and functionality (e.g., speed, accuracy, etc.) of computer-based systems, where the technical solutions can be practically and practicably applied to improve on existing techniques for aligning NN-based models. Implementations of the subject matter disclosed herein provide specific inventive steps describing how desired results are achieved and realize meaningful and significant improvements on existing computer functionality—that is, the performance of computer-based systems operating in the evolving technological field of aligning NN-based models.

In the following description, numerous specific details are set forth such as examples of specific components, circuits, and processes to provide a thorough understanding of the present disclosure. The term “coupled” as used herein means connected directly to or connected through one or more intervening components or circuits. Also, in the following description and for purposes of explanation, specific nomenclature is set forth to provide a thorough understanding of the aspects of the disclosure. However, it will be apparent to one skilled in the art that these specific details may not be required to practice the example implementations. In other instances, well-known circuits and devices are shown in block diagram form to avoid obscuring the present disclosure. Some portions of the detailed descriptions which follow are presented in terms of procedures, logic blocks, processing, and other symbolic representations of operations on data bits within a computer memory.

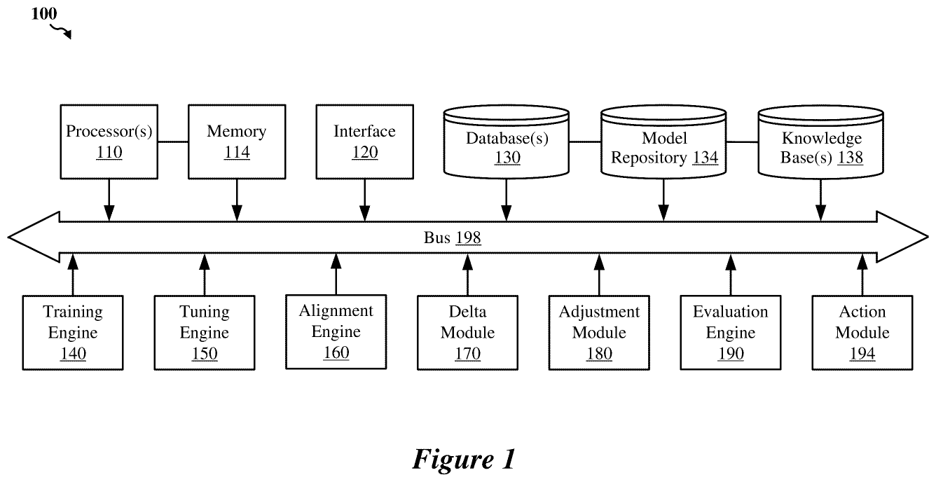

FIG. 1 shows an example computing system 100, according to some implementations. Various aspects of the computing system 100 disclosed herein are generally applicable for aligning a language model (LM) or a large language model (LLM) including a set of neural network (NN) parameters. The computing system 100 includes a combination of one or more processors 110, a memory 114 coupled to the one or more processors 110, an interface 120, one or more databases 130, a model repository 134, one or more knowledge bases 138, a training engine 140, a tuning engine 150, an alignment engine 160, a delta module 170, an adjustment module 180, an evaluation engine 190, and/or an action module 194. In some implementations, the various components of the computing system 100 are interconnected by at least a data bus 198. In some other implementations, the various components of the computing system 100 are interconnected using other suitable signal routing resources.

The processor 110 includes one or more suitable processors capable of executing scripts or instructions of one or more software programs stored in the computing system 100, such as within the memory 114. In some implementations, the processor 110 includes a general-purpose single-chip or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. In some implementations, the processor 110 includes a combination of computing devices, such as a combination of a DSP and a microprocessor, a plurality of microprocessors, one or more microprocessors in conjunction with a DSP core, or any other suitable configuration. In some implementations, the processor 110 incorporates one or more graphics processing units (GPUs) and/or tensor processing units (TPUs), such as for processing a large amount of data. For example, the processor 110 may use the TPUs to adjust millions or billions of NN parameters within seconds or milliseconds.

The memory 114, which may be any suitable persistent memory (such as non-volatile memory or non-transitory memory) may store any number of software programs, executable instructions, machine code, algorithms, and the like that can be executed by the processor 110 to perform one or more corresponding operations or functions. In some implementations, hardwired circuitry is used in place of, or in combination with, software instructions to implement aspects of the disclosure. As such, implementations of the subject matter disclosed herein are not limited to any specific combination of hardware circuitry and/or software.

The interface 120 is one or more input/output (I/O) interfaces for transmitting or receiving (e.g., over a communications network) transmissions, input data, and/or instructions to or from a computing device (e.g., associated with a user), outputting data (e.g., over the communications network) to the computing device, and the like. The interface 120 may also be used to provide or receive other suitable information, such as computer code for updating one or more programs stored on the computing system 100, internet protocol requests and results, or the like. An example interface includes a wired interface or wireless interface to the internet or other means to communicably couple with user devices or any other suitable devices. In an example, the interface 120 includes an interface with an ethernet cable to a modem, which is used to communicate with an internet service provider (ISP) directing traffic to and from user devices and/or other parties. In some implementations, the interface 120 is also used to communicate with another device within the network to which the computing system 100 is coupled, such as a smartphone, a tablet, a personal computer, or other suitable electronic device. In various implementations, the interface 120 includes a display, a speaker, a mouse, a keyboard, or other suitable input or output elements that allow interfacing with the computing system 100 by a local user or moderator.

The database 130 stores data associated with the computing system 100, such as data assets, transmissions, requests, preferences, priorities, timestamps, events, algorithms, modules, engines, user information, historical data, recent data, current or real-time data, files, plugins, metadata, arrays, tags, identifiers, queries, feedback, insights, formats, features, among other suitable information, such as in one or more JavaScript Object Notation (JSON) files, comma-separated values (CSV) files, or other data objects for processing by the computing system 100, one or more Structured Query Language (SQL) compliant data sets for filtering, querying, and sorting by the computing system 100 (e.g., the processor 110), or any other suitable format. In various implementations, the database 130 is a part of or separate from the model repository 134, the knowledge base 138, and/or another suitable physical or cloud-based data store. In some implementations, the database 130 includes a relational database capable of presenting information as data sets in tabular form and capable of manipulating the data sets using relational operators.

The model repository 134 stores data associated with artificial neural network (ANN) models, such as the ANN models themselves (e.g., LMs, LLMs, untrained models, pretrained models, tuned models, aligned models, reward models), NN parameters (e.g., weights, biases, corresponding tensors, current parameter sets, prior parameter sets, parameter delta values), architectures (e.g., layer descriptions, neurons, activation functions, overall structures), training data and related information (e.g., statistics, distribution, size, preprocessing steps, training data, text corpora, tuning data, alignment data, alignment data snapshots, alignment preferences, metric logs, accuracies, loss functions and values), hyperparameters (e.g., learning rates, batch sizes, numbers of epochs), evaluation results (e.g., performance metrics and models, validation data, test sets, benchmark scores, thresholds, receiver operating characteristic (ROC) curves, confusion matrices), versioning information (e.g., iterations, updates), metadata and documentation (e.g., usage instructions, authors), deployment configurations (e.g., settings for deploying models in different environments), monitoring data (e.g., real-time or periodic tracking performance in production), or any other suitable data related to ANN models. In some implementations, the model repository 134 stores tensors in a safetensor format due to its secure nature. The tensors may also be stored in a different format, such as Pickle or directly as PyTorch model checkpoints (.pt or .pth). In various implementations, the model repository 134 may be a part of or separate from the database 130 and/or the knowledge base 138. In some instances, the model repository 134 includes data stored in one or more cloud object storage services, such as one or more Amazon Web Services (AWS)-based Simple Storage Service (S3) buckets. In some implementations, all or a portion of the data is stored in a memory separate from the model repository 134, such as in the database 130 and/or another suitable data store.

The knowledge base 138 stores data associated with task-based fine-tuning, such as factual data used to fine-tune an LM/LLM to perform a particular task, or any other suitable data related to task-based fine-tuning or task-based fine-tuning operations, such as SFT. For example, the knowledge base 138 may store medical textbooks, research papers, and clinical trial data for purposes of fine-tuning an LM to perform medical diagnosis-based tasks. As another example, the knowledge base 138 may store product information, frequently asked questions (FAQs), troubleshooting guides, and customer interaction logs for purposes of fine-tuning an LM to perform customer service chat-based tasks. As another example, the knowledge base 138 may store collections of text from various genres, writing styles, language patterns, story elements, character databases, narrative structures, plot devices, archetypes, and the like, for purposes of fine-tuning an LM to perform tasks related to helping authors generate story ideas, develop characters, and improve their writing style. In various implementations, the fact-based data may be stored in the knowledge base 138 in a relational database (e.g., PostgreSQL), a graph database (Neo4j), a document store (MongoDB), structured data (e.g., JSON, CSV), text files, or another suitable format. The knowledge base 138 may also store pairs of prompts and ideal and/or undesirable outputs, performance metrics, hyperparameter configurations, and the like. In various implementations, the knowledge base 138 may be a part of or separate from the database 130 and/or the model repository 134. In some instances, the knowledge base 138 includes data stored in one or more cloud object storage services, such as one or more Amazon Web Services (AWS)-based Simple Storage Service (S3) buckets. In some implementations, all or a portion of the data is stored in a memory separate from the knowledge base 138, such as in the database 130 and/or another suitable data store.

The training engine 140 performs tasks related to training models. For example, the training engine 140 may be used to pretrain an untrained LM/LLM on a text corpus. The pretraining process may include feeding the text corpus to a base transformer model and training the model to predict a next or missing word in a sequence until the model exhibits an acceptable, broad understanding of language, such as by passing one or more performance evaluations. In some implementations, the pretraining process uses a self-supervised learning approach, where the input text is a supervisory signal. In various implementations, the training engine 140 incorporates one or more of the following algorithms, models, or techniques in the pretraining process: stochastic gradient descent (SGD), masked language modeling (MLM), bidirectional encoder representations from transformers (BERT), causal language modeling (CLM), transformer models, attention mechanisms, recurrent neural networks (RNNs), long short-term memory (LSTM), gated recurrent units (GRUs), byte pair encoding (BPE), tokenization, or the like. In some other implementations, a pretrained LM/LLM is received over a communications network (e.g., the Internet) and may include an open-source or a commercial LM/LLM, such as Mistral, Llama, BLOOM, StableLM, a GPT model, a PaLM model, a Claude model, or the like.

The tuning engine 150 performs task-based fine-tuning of models. For instance, the tuning engine 150 may be used in conjunction with a fine-tuning operation (e.g., supervised fine-tuning (SFT)) to fine-tune a pretrained LM/LLM to perform a downstream task based on tuning data (e.g., a labeled knowledge base) relevant to the downstream task. In some implementations, the downstream task is a general task, such as text translation, sentiment analysis, or question answering. In addition, or in the alternative, the downstream task is a particular specialization. For example, the tuning engine 150 may use a knowledge base of medical textbooks, research papers, and clinical trial data stored in the knowledge base 138 to fine-tune a pretrained LM to perform medical diagnosis-based tasks. As another example, the tuning engine 150 may use a knowledge base of product information, FAQs, troubleshooting guides, and customer interaction logs stored in the knowledge base 138 to fine-tune a pretrained LM to perform customer service chat-based tasks. As another example, the tuning engine 150 may use a knowledge base of text from various genres, writing styles, language patterns, story elements, and character databases stored in the knowledge base 138 to fine-tune a pretrained LM to perform tasks related to helping authors generate story ideas. In some instances, the fine-tuning process includes freezing weights of other layers to prevent catastrophic forgetting, optimizing learning rate hyperparameters, optimizing batch size hyperparameters, performing evaluation benchmarks, iteratively adjusting weights, and the like.

The alignment engine 160 may perform formal alignment operations and/or the alignment engine 160 may be used in conjunction with the delta module 170 and/or the adjustment module 180 to perform the innovative informal model alignment techniques described herein. For instance, the alignment engine 160 may be used to align an LM/LLM (e.g., that is already fine-tuned for a particular task) to generate output that aligns with at least one of a tone, voice, safety, or ethical preference, while refraining from performing a formal alignment operation typically performed during the fine-tuning process (e.g., SFT), such as direct preference optimization (DPO) or reinforcement learning from human feedback (RLHF). Specifically, when delta values are available (as further described below), the tuning engine 150 may refrain from performing the formal alignment operation (e.g., DPO or RLHF) during fine-tuning (e.g., SFT) of an LM/LLM, and the alignment engine 160 may instead perform one or more of the innovative alignment techniques described herein such that an expected output of the LM/LLM aligns with the tone, voice, safety, and/or ethical preferences.

The delta module 170 generates a set of delta values from two sets of NN parameters associated with a same LM/LLM at different times. For example, the delta module 170 may extract a first set of NN parameters from an LM before the LM is aligned using DPO, extract a second set of NN parameters from the LM after the LM is aligned using DPO, and generate a set of delta values representative of a difference between the first and second sets of NN parameters. In some aspects, the NN parameters include a plurality of weights, such as bias weights, attention weights, query weights, key weights, and/or value weights, and each delta value represents a magnitude and/or a direction of a change in the particular weight before-and-after the DPO alignment operation. In some implementations, the difference between the first and second sets of NN parameters is determined by subtracting each parameter in the first set element-wise from the corresponding parameter in the second set. The extracted parameters and generated delta values may be stored in tensors, i.e., multidimensional arrays designed for efficient numerical computation. The tensors may be stored in a high-dimensional space as the LM may include a large number of layers, each with its own parameters, resulting in millions or billions of parameters across the sets of parameters, and thus, millions or billions of delta values.

The adjustment module 180 adjusts model parameters based on delta values. Specifically, the adjustment module 180 may be used to adjust an LM/LLM's NN parameters based on the delta values generated by the delta module 170. In some implementations, once adjusted, an expected, actual, or evaluated output of the LM aligns with a tone, voice, safety, or ethical preference. To note, the output of the LM aligns with the tone, voice, safety, or ethical preference without a formal alignment training or alignment fine-tuning operation having been performed on the LM, such as during SFT. In some implementations, to adjust the model parameters, the adjustment module 180 simultaneously adds, in a high-dimensional tensor space, each respective delta value of a set of delta values to a corresponding parameter of the LM's NN parameters. In some instances, a number of the delta values is in the millions, billions, or trillions, and the simultaneous adding of each delta value is performed at least nearly instantaneously, such as in seconds or milliseconds.

The evaluation engine 190 may be used to evaluate a model's performance after its NN parameters are adjusted. By evaluating and verifying a model's performance after its parameters are adjusted, the evaluation engine 190 may be used to determine an impact of the adjustments and ensure that the model's performance has increased, rather than leading to unintended results. To evaluate performance, the evaluation engine 190 may perform, or otherwise obtain scores for, one or more alignment benchmarking evaluations of the adjusted LM. An alignment benchmarking evaluation may include a dataset of labeled benchmark question prompts (e.g., including a chosen answer and a rejected answer) regarding general ethical principles and values, or a custom set of labeled question prompts that evaluate an adherence of the LM's output with the specific tone, voice, safety, and/or ethical preferences towards which the LM's NN parameters were adjusted. For example, when the delta values are obtained based on a formal alignment operation performed on a prior LM, the evaluation engine 190 may obtain a first score generated based on a first benchmark evaluation of the prior LM, where the first benchmark evaluation determines a quantitative extent to which the prior LM aligns with the specific tone, voice, safety, and/or ethical preferences. Once the parameters of the new LM are adjusted, the evaluation engine 190 may obtain a second score generated based on a second benchmark evaluation of the new LM, where the second benchmark evaluation determines a quantitative extent to which the new LM aligns with the specific tone, voice, safety, and/or ethical preferences. Thereafter, the evaluation engine 190 may determine a difference between the first and second scores, thereby obtaining an alignment-based performance evaluation of the new LM relative to the prior LM.

The action module 194 may be used to perform one or more actions based on the performance evaluations generated by the evaluation engine 190. For instance, once the evaluation engine 190 determines the difference between the first and second evaluation scores of the prior LM and the new LM, respectively, the action module 194 may be used to compare the difference with a threshold, and selectively submit the new LM for deployment based on whether the score difference is above the threshold. The threshold may be a fixed number of score points for a particular evaluation, or the threshold may be a percentage. For example, in some implementations, if the evaluation score for the prior LM is 7.18, the fixed threshold number of score points may be 0.2 points lower, or 6.98 for this example. Thus, for this example, if a new (or “initial”) LM is adjusted by the adjustment module 180 but results in an evaluation score of below 6.98, the action module 194 may refrain from submitting the new LM for deployment. In some other implementations, if the evaluation score for the prior LM is 7.18, the percentage threshold number of score points may be 2% lower, or 7.04. Thus, for this example, if a new LM is adjusted by the adjustment module 180 and results in an evaluation score of at least 7.04, the action module 194 may submit the new LM for deployment. In some implementations, when a new LM meets or exceeds the performance threshold, the action module 194 may automatically deploy the new LM, such as by directly integrating the new LM into a production environment or by making the new LM available via an application programming interface (API). In some other implementations, when a performance score for a new version of an existing LM exceeds the performance score of the existing LM, the action module 194 may automatically update the existing LM with the new version. In some aspects, when a new or update LM fails to meet the performance threshold, the action module 194 may log various performance details, trigger a retraining process (e.g., with augmented data), alert a model developer (e.g., via the interface 120), generate recommendations for improving the adjustment process, provide the recommendations to a human via the interface 120, or the like.

In some implementations, the adjustment module 180 may gradually adjust respective parameters of an LM, such as based on a type of a weight associated with the respective parameter. After each iterative adjustment, the evaluation engine 190 may evaluate a performance of the LM. In this manner, a relative impact of different types of weights on the LM's alignment performance may be determined, thereby allowing the action module 194 to generate smart recommendations for future NN adjustment operations. As one example, the adjustment module 180 may adjust a new LM's parameters corresponding to delta values associated with bias-type weights, and the evaluation engine 190 may determine that the alignment performance score for the iteratively adjusted LM increases by approximately 0.7% (e.g., from 7.06 to 7.11). Continuing this example, the adjustment module 180 may then adjust the new LM's parameters corresponding to delta values associated with attention-type weights, and the evaluation engine 190 may determine that the alignment performance score for the iteratively adjusted LM again increases by approximately 0.7% (e.g., from 7.11 to 7.16). Continuing this example, the adjustment module 180 may then adjust the new LM's parameters corresponding to delta values associated with any remaining weights (e.g., query weights, key weights, value weights), and the evaluation engine 190 may determine that the alignment performance score for the iteratively adjusted LM increases by 1.1% (e.g., from 7.16 to 7.24). Based on the iterative results, the action module 194 may apply relatively similar importance on recommending using delta values to adjust bias-type weights and attention-type weights of an LM, and may apply a relatively higher importance on recommending using delta values to adjust the set of query weights, key weights, and value weights of an LM. In some other implementations, the recommendations may be based on a performance increase per adjusted parameter. For example, if the evaluation engine 190 determines that the adjustment module 180 adjusted 10 billion bias-type parameters to achieve the first alignment performance increase of 0.7% and adjusted 1 billion attention-type parameters to achieve the second alignment performance increase of 0.7%, the action module 194 may apply a 10 times higher importance on recommending using delta values to adjust attention-type parameters of an LM due to the 10 times increased efficiency of doing so.

The training engine 140, the tuning engine 150, the alignment engine 160, the delta module 170, the adjustment module 180, the evaluation engine 190, and/or the action module 194 are implemented in software, hardware, or a combination thereof. In some implementations, any one or more of the training engine 140, the tuning engine 150, the alignment engine 160, the delta module 170, the adjustment module 180, the evaluation engine 190, or the action module 194 is embodied in instructions that, when executed by the processor 110, cause the computing system 100 to perform operations. In various implementations, the instructions of one or more of said components, the interface 120, the model repository 134, and/or knowledge base 138, are stored in the memory 114, the database 130, or a different suitable memory, and are in any suitable programming language format for execution by the computing system 100, such as by the processor 110. It is to be understood that the particular architecture of the computing system 100 shown in FIG. 1 is but one example of a variety of different architectures within which aspects of the present disclosure can be implemented. For example, in some implementations, components of the computing system 100 are distributed across multiple devices, included in fewer components, and so on. While the below examples related to aligning LMs/LLMs are described with reference to the computing system 100, other suitable system configurations may be used.

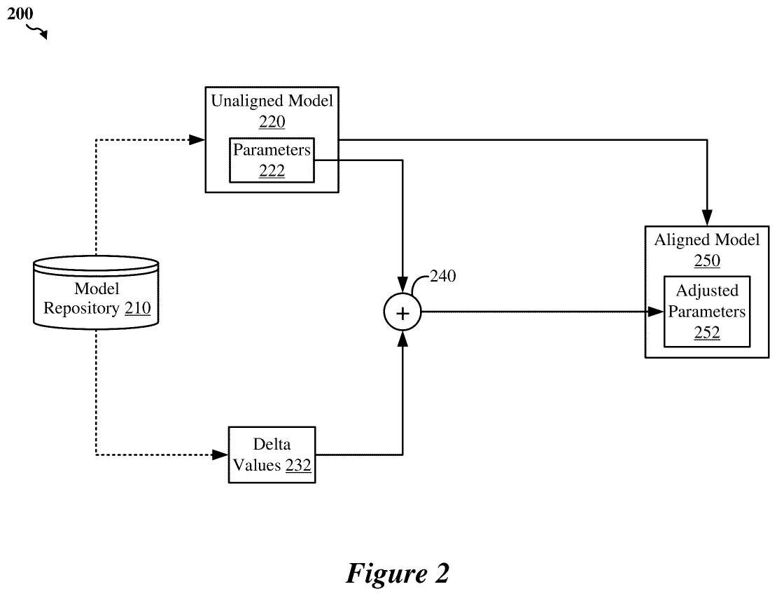

FIG. 2 shows an example process flow 200 for aligning a model, according to some implementations, and may be performed by a computing system, such as the computing system 100 described with respect to FIG. 1. The example process flow 200 shows a model repository 210, which may be an example of the model repository 134 described with respect to FIG. 1. The example process flow 200 starts with obtaining an unaligned model 220 including parameters 222, and obtaining delta values 232. The unaligned model 220 may be an example of a pretrained model and/or a tuned model as described with respect to FIG. 1. The unaligned model 220 and the delta values 232 may be received from the model repository 210. In some instances, the unaligned model 220 and/or the delta values 232 are received from a different source, such as the Internet. At combination 240, the parameters 222 are adjusted using the delta values 232, such as in one or more of the manners described with respect to the adjustment module 180 of FIG. 1. As a result of the adjustment, the unaligned model 220 becomes the aligned model 250 including adjusted parameters 252.

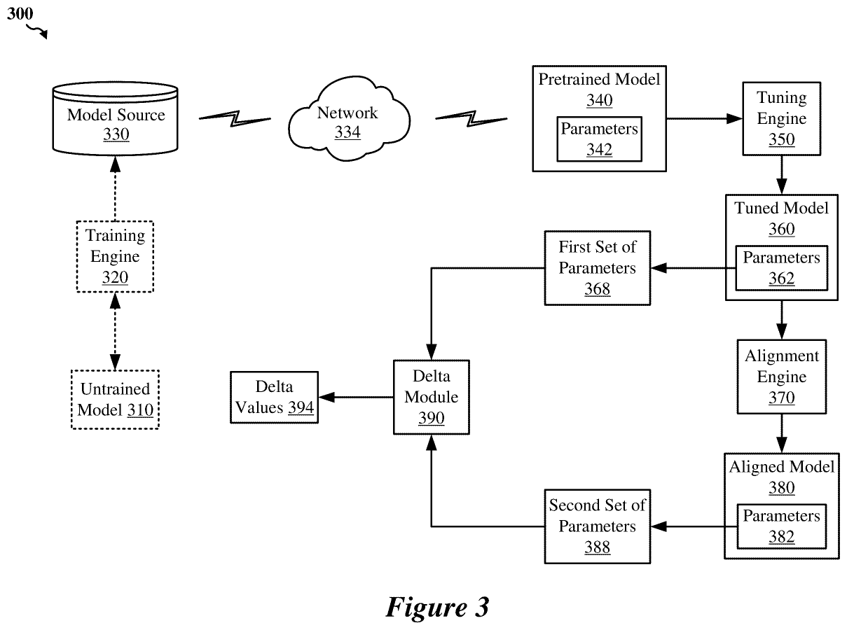

FIG. 3 shows an example process flow 300 for generating delta values, according to some implementations, and may be performed by a computing system, such as the computing system 100 described with respect to FIG. 1. The example process flow 300 shows a training engine 320, a tuning engine 350, an alignment engine 370, and a delta module 390, which may be examples of the training engine 140, the tuning engine 150, the alignment engine 160, and the delta module 170 described with respect to FIG. 1, respectively.

The example process flow 300 starts with receiving, over a network 334 from a model source 330, a pretrained model 340 including parameters 342. As one example, the pretrained model 340 may be a Mistral 7B large language model (LLM), the network 334 may be the Internet, and the model source 330 may be an Internet database hosted by Mistral AI. In some other implementations, the pretrained model 340 is received from a non-Internet based model repository, such as the model repository 134 described with respect to FIG. 1, and the network 334 may be a local network. In such implementations, the computing system 100 may be used to generate the pretrained model 340 by performing pretraining operations on an untrained model 310 (e.g., a base Transformer model), such as by using the training engine 320 in one or more of the manners described with respect to FIG. 1.

The tuning engine 350 transforms the pretrained model 340 into a tuned model 360 including parameters 362, such as by using one or more of the task-based fine-tuning techniques or operations described with respect to the tuning engine 150 of FIG. 1, such as supervised fine-tuning (SFT). A first set of parameters 368 is stored based on (e.g., a snapshot of) the parameters 362, such as by using one or more of the parameter extraction techniques described with respect to the delta module 170 of FIG. 1.

The alignment engine 370 transforms the tuned model 360 into an aligned model 380 including parameters 382, such as by using one or more of the formal alignment operations described above, such as direct preference optimization (DPO) or reinforcement learning from human feedback (RLHF). A second set of parameters 388 is stored based on (e.g., a snapshot of) the parameters 382, such as by using one or more of the parameter extraction techniques described with respect to the delta module 170 of FIG. 1. In some implementations, the alignment engine 370 performs the formal alignment operation as part of the process of the tuning engine 350 performing the task-based fine-tuning operation. In such implementations, the first set of parameters 368 is extracted prior to the formal alignment portion of the fine-tuning operation, and the second set of parameters 388 is extracted after the formal alignment portion of the fine-tuning operation.

The delta module 390 generates delta values 394 based on the first set of parameters 368 and the second set of parameters 388, such as in one or more of the manners described with respect to the delta module 170 of FIG. 1. In some implementations not shown, the delta values 394 may be stored in a suitable database, such as the model repository 134 described with respect to FIG. 1.

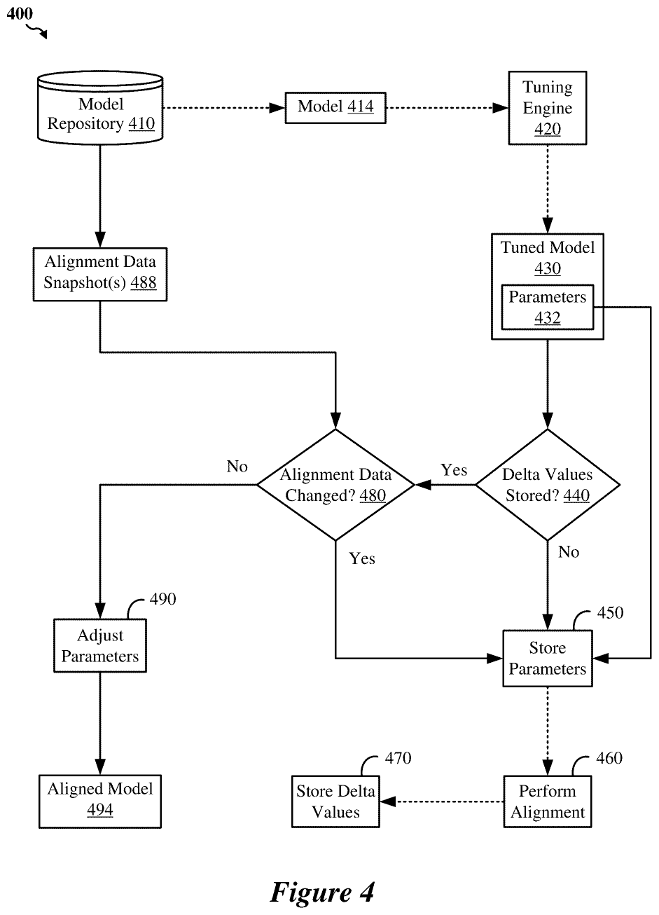

FIG. 4 shows an example process flow 400 for selectively generating delta values or aligning a model using delta values, according to some implementations, and may be performed by a computing system, such as the computing system 100 described with respect to FIG. 1. The example process flow 400 shows a model repository 410 and a tuning engine 420, which may be examples of the model repository 134 and the tuning engine 150 described with respect to FIG. 1, respectively.

The example process flow 400 starts with obtaining a tuned model 430 including parameters 432. In some implementations, the tuning engine 420 is used to transform a model 414 (e.g., a pretrained model) into the tuned model 430 in one or more of the manners described with respect to the tuning engine 150 of FIG. 1. In such implementations, the model 414 may be received from the model repository 410. In some other implementations, the model 414 may be received over the Internet.

At decision block 440, the computing system 100 determines whether delta values are stored. Upon determining whether delta values have been stored and are available in an accessible database (e.g., the model repository 410), an alignment engine (e.g., the alignment engine 160 described with respect to FIG. 1) may selectively perform a formal alignment operation on the tuned model 430 (e.g., as part of the fine-tuning process) based on the determination. In some implementations, multiple sets of delta values may be stored, and the computing system 100 may also determine whether any of the multiple sets of delta values are applicable to the specific tuned model 430, such as based on matching metadata associated with the delta values and the tuned model 430.

If, at decision block 440, the computing system 100 determines that delta values applicable to the tuned model 430 have not been stored or are not available, the example process flow 400 proceeds to block 450 where the parameters 432 are stored. The stored parameters may be one example of the first set of parameters 368 described with respect to FIG. 3. Thereafter, at block 460, the formal alignment operation may be performed on the tuned model 430, and resultant delta values may be stored at block 470, such as in one or more of the manners described with respect to FIG. 3.

If, at decision block 440, the computing system 100 determines that stored delta values applicable to the tuned model 430 are available, the example process flow 400 proceeds to decision block 480 where the computing system 100 determines whether alignment data used in performing the formal alignment operation involved in the generating of the applicable delta values has changed since the formal alignment operation was performed. In some implementations, the computing system 100 may determine whether the alignment data has changed based on a single metadata bit associated with the stored delta values, where the bit is automatically changed to “1” when the alignment data used during the process of generating the delta values changes. In some other implementations, the computing system 100 may directly determine whether the alignment data has changed based on obtaining alignment data snapshots 488 from the model repository 410, where a first snapshot represents the alignment data at a time of the performance of the formal alignment operation, and a second snapshot represents the current alignment data. Thereafter, the computing system 100 may determine whether the alignment data has changed based on whether the first snapshot matches the second snapshot.

If, at decision block 480, it is determined that the alignment data has changed, the example process flow 400 proceeds to block 450 and continues in the manners described above. In some implementations, if the alignment data has changed, the computing system 100 also determines whether the alignment data has changed by more than a threshold level of change, and selectively proceeds to block 450 from decision block 480 based on whether the alignment data has changed by more than the threshold level of change.

If, at decision block 480, the computing system 100 determines that the alignment data has not changed (at least by the threshold level of change), the example process flow 400 proceeds to block 490, where the parameters 432 of the tuned model 430 are adjusted so as to generate an aligned model 494, such as by using the applicable delta values in conjunction with one or more of the techniques described in connection with the adjustment module 180 of FIG. 1. The aligned model 494 may be one example of the aligned model 250 of FIG. 2 and/or the aligned model 380 of FIG. 3.

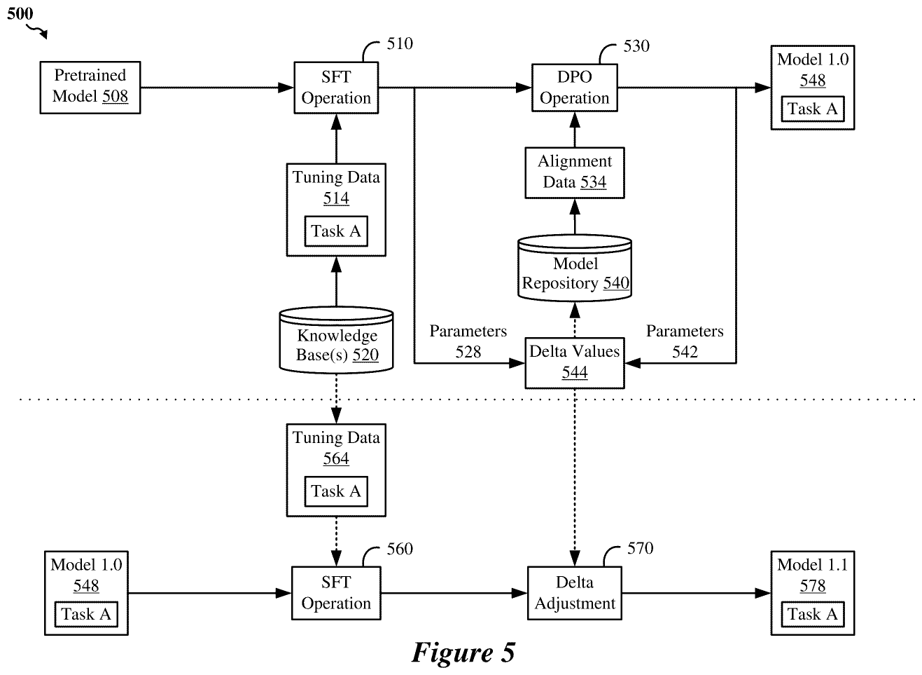

FIG. 5 shows an example process flow 500 for aligning an update model, according to some implementations, and may be performed by a computing system, such as the computing system 100 described with respect to FIG. 1. The example process flow 500 shows a knowledge base 520 and a model repository 540, which may be examples of the knowledge base 138 and the model repository 134 described with respect to FIG. 1, respectively.

The example process flow 500 starts at block 510 by performing a supervised fine-tuning (SFT) operation on a pretrained model 508. The pretrained model 508 may be an example of the pretrained model 340 described with respect to FIG. 3, and the SFT operation may be an example of one of the task-based fine-tuning techniques described with respect to FIG. 1. For example, a tuning engine (e.g., the tuning engine 150 described with respect to FIG. 1) may perform the SFT operation to fine-tune the pretrained model 508 to perform Task A based on tuning data 514 received from knowledge base 520, where the tuning data 514 is labeled and relevant to Task A.

The example process flow 500 continues at block 530 by performing a direct preference optimization (DPO) operation on the model, where the DPO operation may be an example of one of the formal alignment operations described herein. For example, an alignment engine (e.g., the alignment engine 160 described with respect to FIG. 1) may perform the DPO operation to align an expected output of the model with one or more tone, voice, safety, and/or ethical preferences indicated by alignment data 534. The alignment data 534 may be labeled and obtained from the model repository 540. Parameters 528 of the model may be extracted prior to the DPO operation performed at block 530, and parameters 542 of the model may be stored after the DPO operation performed at block 530. The parameters 528 and the parameters 542 may be examples of the first set of parameters 368 and the second set of parameters 388 described with respect to FIG. 3, respectively. Delta values 544 may be generated based on parameters 528 and parameters 542, such as in one or more of the manners described with respect to the delta values 394 of FIG. 3. In some instances, the delta values 544 are stored in the model repository 540.

As a result of the SFT operation performed at block 510 and the DPO operation performed at block 530, the pretrained model 508 is transformed into model 1.0 548, now fine-tuned to perform Task A and formally aligned to generate output that aligns with the one or more tone, voice, safety, and/or ethical preferences indicated by the alignment data 534.

The horizontal dotted line indicates a passage of time during which additional and/or different tuning data associated with Task A may become available, thus motivating a desire to update model 1.0 548 with the new tuning data. Notably, although the task-based tuning data associated with Task A may change frequently over time, it will be understood that the alignment data-indicative of the tone, voice, safety, and/or ethical preferences—is less likely to change over time. Accordingly, the example process flow 500 continues at block 560 by performing an SFT operation on the model 1.0 548. For example, the tuning engine 150 may perform the SFT operation to further fine-tune the model 1.0 548 to more effectively perform Task A based on new tuning data 564 obtained from knowledge base 520.

At block 570, the delta values 544 are used to adjust the parameters of model 1.0 548, such as in one or more of the manners described with respect to the adjustment module 180 of FIG. 1. As a result of the additional SFT operation performed at block 560 and the delta adjustment performed at block 570—and without performing an additional formal alignment operation on the model 1.0 548—the model 1.0 548 is transformed into model 1.1 578, now fine-tuned to more effectively perform Task A and aligned to generate output that aligns with the one or more tone, voice, safety, and/or ethical preferences indicated by the alignment data 534.

In some implementations not shown, the model 1.1 578 may undergo one or more benchmark evaluations to validate whether the delta adjustment performed at block 570 effectively instilled the one or more tone, voice, safety, and/or ethical preferences into the model's output. In some other implementations not shown, the Task A-based SFT operation at block 560 may instead be performed on a fresh instance of a pretrained model (rather than the model 1.0 548), and the delta values 544 may be used to adjust the fine-tuned model's parameters at block 570. Thereafter, the adjusted model may undergo the one or more benchmark evaluations to validate whether the delta adjustment effectively instilled the one or more tone, voice, safety, and/or ethical preferences into the model's output.

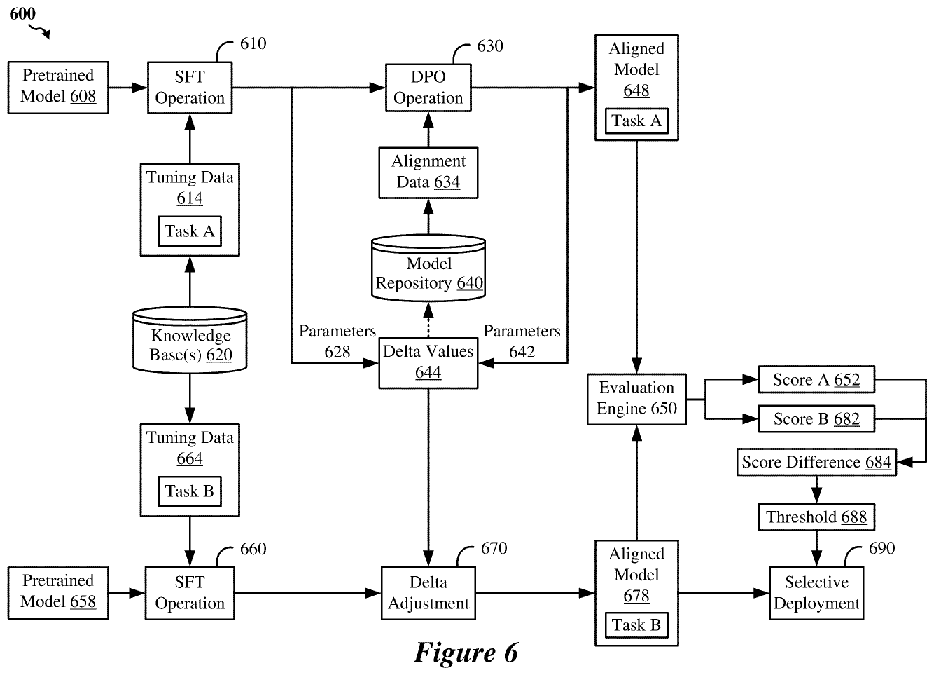

FIG. 6 shows an example process flow 600 for aligning an initial model, according to some implementations, and may be performed by a computing system, such as the computing system 100 described with respect to FIG. 1. The example process flow 600 shows a knowledge base 620, a model repository 640, and an evaluation engine 650, which may be examples of the knowledge base 138, the model repository 134, and the evaluation engine 190 described with respect to FIG. 1, respectively.

The example process flow 600 starts at block 610 by performing a supervised fine-tuning (SFT) operation on a pretrained model 608. The pretrained model 608 may be an example of the pretrained model 508 described with respect to FIG. 5. For example, a tuning engine (e.g., the tuning engine 150 described with respect to FIG. 1) may perform the SFT operation to fine-tune the pretrained model 608 to perform Task A based on tuning data 614 received from knowledge base 620, where the tuning data 614 is labeled and relevant to Task A.

The example process flow 600 continues at block 630 by performing a direct preference optimization (DPO) operation on the model. For example, an alignment engine (e.g., the alignment engine 160 described with respect to FIG. 1) may perform the DPO operation to align an expected output of the model with one or more tone, voice, safety, and/or ethical preferences indicated by alignment data 634. The alignment data 634 may be labeled and obtained from the model repository 640. Parameters 628 of the model may be extracted prior to the DPO operation performed at block 630, and parameters 642 of the model may be stored after the DPO operation performed at block 630. The parameters 628 and the parameters 642 may be examples of the first set of parameters 368 and the second set of parameters 388 described with respect to FIG. 3, respectively. Delta values 644 may be generated based on parameters 628 and parameters 642, such as in one or more of the manners described with respect to the delta values 394 of FIG. 3. In some instances, the delta values 644 are stored in the model repository 640.

As a result of the SFT operation performed at block 610 and the DPO operation performed at block 630, the pretrained model 608 is transformed into aligned model 648, now fine-tuned to perform Task A and formally aligned to generate output that aligns with the one or more tone, voice, safety, and/or ethical preferences indicated by the alignment data 634. In some implementations, an alignment benchmark evaluation is performed on aligned model 648 by the evaluation engine 650, thereby generating score A 652, such as in one or more of the manners described with respect to the evaluation engine 190 of FIG. 1.

The example process flow 600 continues at block 660 by performing an SFT operation on a different initial pretrained model 658. For example, the tuning engine 150 may perform the SFT operation to fine-tune the pretrained model 658 to perform Task B based on tuning data 664 obtained from knowledge base 620. Notably, Task A may be substantially different than Task B, such as the different task examples described with respect to FIG. 1, and thus the tuning data 664 may be substantially different than the tuning data 614.

At block 670, the previously generated delta values 644 are used to adjust the parameters of the fine-tuned version of the pretrained model 658, such as in one or more of the manners described with respect to the adjustment module 180 of FIG. 1. As a result of the SFT operation performed at block 660 and the delta adjustment performed at block 670—and without performing a formal alignment operation on the pretrained model 658 before, during, or after its fine-tuning—the pretrained model 658 is transformed into aligned model 678, now fine-tuned to perform Task B and aligned to generate output that aligns with the one or more tone, voice, safety, and/or ethical preferences indicated by the alignment data 634. In some implementations, an alignment benchmark evaluation is performed on aligned model 678 by the evaluation engine 650, thereby generating score B 682. Thereafter, a score difference 684 may be generated based on score A 652 and score B 682, the score difference 684 may be compared with a threshold 688, and aligned model 678 may be selectively deployed based on the comparison at block 690, such as in one or more of the manners described with respect to the evaluation engine 190 and the action module 194 of FIG. 1.

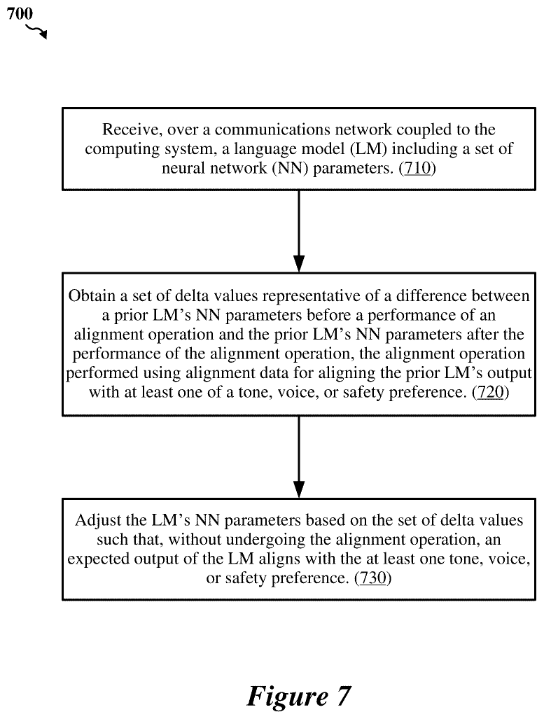

FIG. 7 shows an illustrative flowchart 700 depicting an example operation for aligning a language model (LM), according to some implementations, and may be performed by a computing system, such as the computing system 100 described with respect to FIG. 1. For example, at 710, the computing system 100 receives, over a communications network coupled to the computing system, an LM including a set of neural network (NN) parameters. At 720, the computing system 100 obtains a set of delta values representative of a difference between a prior LM's NN parameters before a performance of an alignment operation and the prior LM's NN parameters after the performance of the alignment operation, the alignment operation performed using alignment data for aligning the prior LM's output with at least one of a tone, voice, or safety preference. At 730, the computing system 100 adjusts the LM's NN parameters based on the set of delta values such that, without undergoing the alignment operation, an expected output of the LM aligns with the at least one tone, voice, or safety preference.

As used herein, a phrase referring to “at least one of” a list of items refers to any combination of those items, including single members. As an example, “at least one of: a, b, or c” is intended to cover: a, b, c, a-b, a-c, b-c, and a-b-c.

Unless specifically stated otherwise as apparent from the following discussions, it is appreciated that throughout the present application, discussions utilizing the terms such as “accessing,” “receiving,” “sending,” “using,” “selecting,” “determining,” “normalizing,” “multiplying,” “averaging,” “monitoring,” “comparing,” “applying,” “updating,” “measuring,” “deriving” or the like, refer to the actions and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The various illustrative logics, logical blocks, modules, circuits, and algorithm processes described in connection with the implementations disclosed herein may be implemented as electronic hardware, computer software, or combinations of both. The interchangeability of hardware and software has been described, in terms of functionality, and illustrated in the various illustrative components, blocks, modules, circuits and processes described above. Whether such functionality is implemented in hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example implementations, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can include a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

Various modifications to the implementations described in this disclosure may be readily apparent to those skilled in the art, and the generic principles defined herein may be applied to other implementations without departing from the spirit or scope of this disclosure. Thus, the claims are not intended to be limited to the implementations shown herein but are to be accorded the widest scope consistent with this disclosure, the principles and the novel features disclosed herein.

What is claimed is:

1. A method for aligning a language model (LM), the method performed by one or more processors of a computing system and comprising:
receiving, over a communications network coupled to the computing system, an LM including a set of neural network (NN) parameters;
obtaining a set of delta values representative of a difference between a prior LM's NN parameters before a performance of an alignment operation and the prior LM's NN parameters after the performance of the alignment operation, the alignment operation performed using alignment data for aligning the prior LM's output with at least one of a tone, voice, or safety preference; and
adjusting the LM's NN parameters based on the set of delta values such that, without undergoing the alignment operation, an expected output of the LM aligns with the at least one tone, voice, or safety preference.

2. The method of claim 1, wherein the LM is a large language model (LLM) pretrained using a text corpus.

3. The method of claim 1, wherein the LM's NN parameters include a plurality of weights.

4. The method of claim 3, wherein the plurality of weights include at least one of bias weights, attention weights, query weights, key weights, or value weights.

5. The method of claim 1, wherein the set of delta values is stored in a set of tensors.

6. The method of claim 5, wherein the set of tensors is stored in a safetensor format.

7. The method of claim 5, wherein adjusting the LM's NN parameters includes:
simultaneously adding, in a high-dimensional tensor space, each respective delta value of the set of delta values to a parameter of the LM's NN parameters that corresponds to the respective delta value, wherein the simultaneous adding of each delta value is performed at least nearly instantaneously.

8. The method of claim 1, wherein the alignment operation includes at least one of a direct preference optimization (DPO) operation or a reinforcement learning (RL) operation.

9. The method of claim 1, further comprising:
obtaining a first snapshot of the alignment data stored at a time of the performance of the alignment operation;
obtaining a second snapshot of current alignment data; and
determining that the first snapshot matches the second snapshot, wherein the set of delta values is obtained responsive to the determining.

10. The method of claim 1, wherein:
a first set of the prior LM's NN parameters is determined before the performance of the alignment operation;
a second set of the prior LM's NN parameters is determined after the performance of the alignment operation; and
the difference is generated based on the first and second sets of the prior LM's NN parameters.

11. The method of claim 10, wherein the first set of the prior LM's NN parameters is determined after a first fine-tuning operation is performed on the prior LM.

12. The method of claim 11, wherein the first fine-tuning operation includes a supervised fine-tuning (SFT) operation.

13. The method of claim 11, wherein the first fine-tuning operation is performed using tuning data for fine-tuning the prior LM to perform a first task based on a first knowledge base.

14. The method of claim 13, further comprising:
performing, prior to adjusting the LM's NN parameters, the first fine-tuning operation on the LM such that the LM performs the first task based on the first knowledge base.

15. The method of claim 14, wherein the LM is an update model of the prior LM.

16. The method of claim 13, further comprising:
performing, prior to adjusting the LM's NN parameters, a second fine-tuning operation on the LM such that the LM performs a second task different than the first task.

17. The method of claim 16, wherein the LM is an initial model fine-tuned for performing the second task based on a second knowledge base different than the first knowledge base.

18. The method of claim 1, further comprising:
obtaining a first score generated based on a first benchmark evaluation of the prior LM, wherein the first benchmark evaluation determines a quantitative extent to which the prior LM aligns with the at least one tone, voice, or safety preference;
obtaining a second score generated based on a second benchmark evaluation of the LM, wherein the second benchmark evaluation determines a quantitative extent to which the LM aligns with the at least one tone, voice, or safety preference; and
comparing a score difference between the first and second scores with a threshold.

19. The method of claim 18, further comprising:
selectively submitting the LM for deployment based on whether the score difference is above the threshold.

20. A system for aligning a language model (LM), the system comprising:
one or more processors; and
at least one memory coupled to the one or more processors and storing instructions that, when executed by the one or more processors, cause the system to perform operations including:
receiving, over a communications network coupled to a computing system, an LM including a set of neural network (NN) parameters;
obtaining a set of delta values representative of a difference between a prior LM's NN parameters before a performance of an alignment operation and the prior LM's NN parameters after the performance of the alignment operation, the alignment operation performed using alignment data for aligning the prior LM's output with at least one of a tone, voice, or safety preference; and
adjusting the LM's NN parameters based on the set of delta values such that, without undergoing the alignment operation, an expected output of the LM aligns with the at least one tone, voice, or safety preference.
